(19) United States
(12) Patent Application Publication
(10) Pub. No.: US 2016/0018327 A1
(43) Pub. Date: Jan. 21, 2016

(54) Differential OCT Analysis System

(71) Applicant: Joshua Noel HOGAN, Los Altos, CA (US)

(72) Inventor: Joshua Noel Hogan, Los Altos, CA (US)

(21) Appl. No.: 14/773,379

(22) PCT Filed: Oct. 29, 2014
(86) PCT No.: PCT/US14/62979

§ 371 Date: Sep. 7, 2015

Related U.S. Application Data
(60) Provisional application No. 61/926,350, filed on Jan. 12, 2014.
(60) Provisional application No. 61/905,186, filed on Nov. 16, 2013.
(60) Provisional application No. 61/898,496, filed on Nov. 1, 2013.

(51) Int. Cl. G01N 21/47; G01B 9/02

(52) U.S. Cl. CPC G01N 21/47; G01B 9/02091

(57) ABSTRACT

A method, apparatus and system for enhanced OCT measurement is described. The invention provides for using an OCT system with two or more optical sources with different wavelengths from each other to analyze tissue and measure scattering characteristics and absorption properties of a target. Embodiments include using multiple differential states: multiple wavelengths; multiple pressure wave environments; and multiple temperatures. Embodiments also include using temperature stabilization and speckle reduction by means of subjecting the target to one or more pressure waves.

### CROSS REFERENCES TO RELATED PATENTS OR APPLICATIONS

This patent application, docket number CI141029PT claims priority from provisional patent applications 61898496 (docket number CI131030PR filed on 1 Nov. 2013, titled Multiple Wavelength OCT Analysis System); 61/905,186 (docket number CI131116PR filed on 16 Nov. 2013 titled Multiple Wavelength OCT System with Temperature Control); and 61926350 (docket number CI140101PR filed on 12 Jan. 2014 titled Differential Wavelength OCT Analysis System). This patent application is also related to the following US patents: U.S. Pat. No. 8,570,528 titled “Dual wavelength scanning system”; U.S. Pat. No. 7,248,907 titled “Correlation of concurrent non-invasively acquired signals”; U.S. Pat. No. 7,526,329 titled Multiple Reference Non-invasive Analysis System; U.S. Pat. No. 7,751,862 titled Frequency Resolved Imaging System; and U.S. Pat. No. 8,310,681 titled Orthogonal reference analysis system with enhanced SNR. The contents of provisional patent Nos. 61/898,496, 61/905,186 and 61/926,350 and of U.S. Pat. Nos. 8,570,528; 8,310,681, 7,248,907; 7,526,329 and 7,751,862 are incorporated herein as if fully set forth herein. This application, docket number CI141029PT, is also related to patent application PCT/US2013/064738, titled “Enhanced OCT Measurement and Imaging Apparatus and Method” with file date Oct. 12, 2013, the contents of which is incorporated herein as if fully set forth herein.

### FIELD OF THE INVENTION

The invention described and illustrated in this application relates to the field of Optical Coherence Tomography (OCT) imaging and analysis systems. In particular the invention relates to improved measurement of scattering characteristics of targets by such OCT systems.

This invention also relates to the use of such OCT systems for non-invasive imaging and analysis of targets and non-invasive analysis of concentrations of specific components or analytes in a target, such as the concentration of glucose in blood, tissue fluids, tissue, or components of an eye or other biological entities.

### BACKGROUND OF THE INVENTION

OCT has been explored as a technique for measuring glucose concentration. For example U.S. Pat. No. 6,725,073 by Motamedi, et al., titled “Methods for noninvasive analyte sensing” describes using OCT to measure glucose concentration. U.S. Pat. No. 7,526,329 by Hogan and Wilson titled “Multiple reference non-invasive analysis system” describes using a variant of time domain OCT to measure glucose concentration.

These approaches exploit a correlation between blood glucose concentration and the scattering coefficient of tissue that has been reported in Optics Letters, Vol. 19, No. 24, Dec. 15, 1994 pages 2062-2064. The sensitivity of an OCT signal to glucose concentration is described in a paper titled “Specificity of noninvasive blood glucose sensing using optical coherence tomography technique: a pilot study”, Phys. Med. Biol. 48 (2003) pp. 1371-1390 by Larin et al.

An alternate approach to measuring glucose concentration using OCT, but involving a sensitivity to different temperatures is described in U.S. Pat. No. 8,078,244 by Melman, et al., titled “Interferometric method and instrument for measurement and monitoring blood glucose through measurement of tissue refractive index”. However, the speed of this approach is severely limited owing to the rate at which the temperature change can be accomplished and, this slowness makes measurement both uncertain and imprecise because of target motion during measurement.

Another approach to measuring glucose concentration using OCT is described in the patent application Ser. No. 13/991,061 with docket number CI120925PC (incorporated herein). This approach uses the application of different pressure wave environments to enhance sensitivity to glucose measurement.

### SUMMARY OF THE INVENTION

The invention described herein provides a method, apparatus and system for enhanced OCT measurement of glucose concentration in tissue fluids. The invention provides for using an OCT system with two or more optical sources with different wavelengths from each other to analyze tissue and measure scattering characteristics and absorption properties of components of tissue and deriving a glucose concentration value based on the measured scattering characteristics at different wavelengths or different wavelength ranges. An embodiment includes using multiple differential states: multiple wavelengths; multiple pressure wave environments; and multiple temperatures.

### BRIEF DESCRIPTION OF THE DRAWINGS

FIG. 1 is a schematic type illustration of an embodiment of the analysis system according to the invention depicting an OCT system that simultaneously measures scattering characteristics at two different wavelength ranges.

FIG. 2 is an illustration of an embodiment of the invention using pressure wave environments to improve the sensitivity of OCT measurements.

FIG. 3 is an illustration of an embodiment of the invention using induction heating to improve the sensitivity of OCT measurements.

FIG. 4 is an illustration of an aspect of the invention using a heat pump and a pressure wave generator to improve the sensitivity of OCT measurements.

FIG. 5 is a schematic type illustration of a preferred embodiment of the analysis system according to the invention depicting an OCT system that simultaneously measures scattering characteristics at two different wavelength ranges.

### DETAILED DESCRIPTION OF THE INVENTION

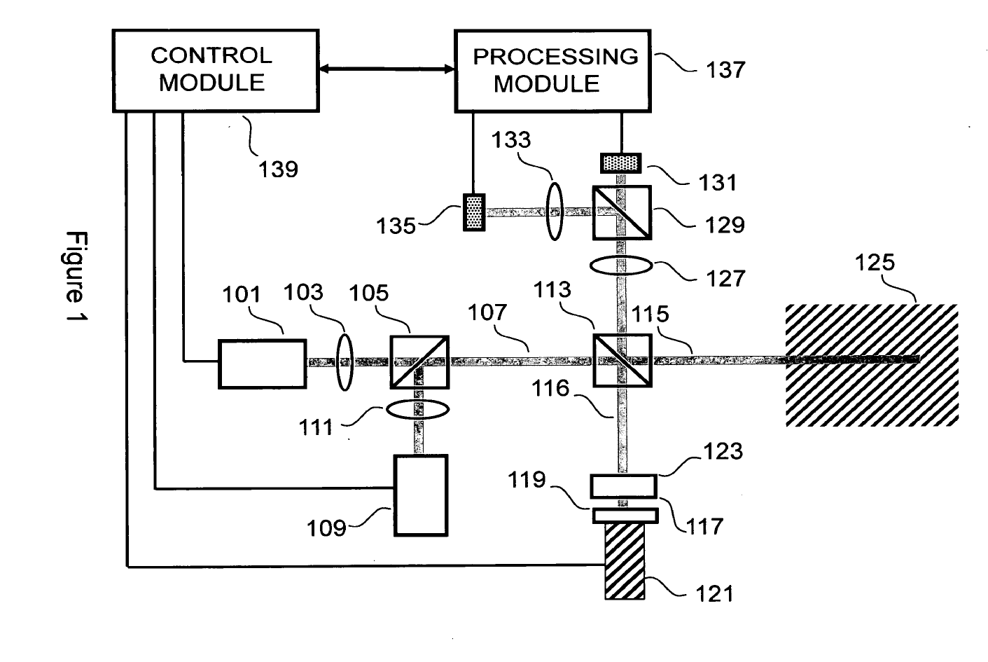

One embodiment of the invention is illustrated in FIG. 1 where a broadband optical source 101 generates broadband radiation with a wavelength range centered at a first wavelength. The first wavelength radiation is focused by a lens 103, through a first beam-splitter 105 that is transmissive (that is to say, transparent) for radiation at the first wavelength range.

The first wavelength radiation is split into probe and reference radiation by a second beam-splitter 113. The probe radiation is directed at the target 125 and the reference radiation 116 is directed through a surface 123 that is anti-reflection coated and highly transmissive at the first wavelength range, through a second surface 117 that is partially reflective at the first wavelength range to a third surface 119 that is highly reflective at the first wavelength range.

The highly reflective surface 119 is mounted on an optical path length varying device 121, which, in the preferred embodiment, is a length varying piezo device, voice coil, or vertical MEMs device. The combination of the highly reflective surface 119 on the length varying piezo device 121 and the partial reflective surface 117 imposes different frequency content on different components of the reference radiation to form composite reference radiation reference radiation which in turn imposes different frequency content on the interferometric signals resulting from combining captured scattered probe radiation with the composite reference radiation as described in U.S. Pat. No. 7,526,329 titled Multiple Reference Non-invasive Analysis System and U.S. Pat. No. 7,751,862 titled Frequency Resolved Imaging System, the contents of both of which are incorporated by reference as if fully set forth herein.

The resulting composite interference signals are detected and processed to achieve a scan of the target that consists of a first set of scan segments that form a composite depth scan of a region of interest of the target 125.

A second broadband optical source 109 generates broadband radiation with a wavelength range centered at a second wavelength (where the second wavelength is different from the first wavelength). The second wavelength radiation is focused by a lens 111. The second wavelength radiation is combined with the first wavelength radiation by means of the beam-splitter 105 that is reflective for radiation at the second wavelength range. When combined, the first wavelength radiation and the second wavelength radiation are substantially co-linear.

The second wavelength radiation is also split into probe and reference radiation by the second beam-splitter 113. The portion that is probe radiation is also directed at the target 125 and the portion that is reference radiation 116 is directed through a surface 123 that is also anti-reflection coated and highly transmissive at the second wavelength range, through the surface 117 that is also partially reflective at the second wavelength range to the third surface 119 that is also highly reflective at the second wavelength range.

The combination of the highly reflective surface 119 on the length varying piezo device 121 and the partial reflective surface 117 imposes different frequency content on different components of this portion of the reference radiation to form composite reference radiation at the second wavelength range which in turn imposes different frequency content on the interferometric signals resulting from combining captured scattered probe radiation with the composite reference radiation as described in above referenced U.S. Pat. Nos. 7,526,329 and 7,751,862.

The resulting composite interference signals are detected and processed to achieve a scan of the target that consists of a second set of scan segments that form a composite depth scan of a region of the target 125 that is substantially the same as the region of the target scanned by the first wavelength radiation.

In this embodiment the composite interferometric signal that is formed by combining said captured scattered probe radiation associated with the second wavelength range is separated from that associated with the first wavelength range by means of a third beam-splitter 129 that is transmissive (or transparent) at the first wavelength range and reflective at the second wavelength range (or visa versa).

Separating the interferometric signals in this manner enables their detection by detectors 131 and 135 with an appropriate focusing arrangement, for example by means of lenses 127 and 133. It can be appreciated that in some configurations, lenses may not be required. For example, in a very compact miniature configuration with detectors with sufficiently large detection area lenses may not be required.

A control module 139 provides: timing signals (clock, data capture, etc.) to the processing module 137; the modulating drive signal to the length varying device 121; and, typically, drive and temperature control signals to the optical sources 101 and 109.

The detected signals at the two different wavelength ranges can be processed in a coordinated manner because they both share the partial reflective surface 117, the highly reflective surface 119 and are both modulated by the same length varying device 121, which ensures the reference signals of both sets of scan segments substantially correspond to the same region of the target.

In particular the detected signals at the two different wavelength ranges are processed to generate scattering characteristics at different depths within the target for the two different wavelength ranges. Such scattering characteristics include, but are not limited to, a depth scattering profile of the target and scattering coefficients.

Having scattering characteristics of the same region of the target, but acquired at at least two different wavelength ranges enables combining the information at the two different wavelength ranges to form a differential signal that is substantially independent of the effects of the local structure of the target.

For example a differential signal is generated by subtracting the processed signals acquired at the different wavelength ranges. Processing of these signals can include typical de-convoluting the acquired raw interference signals with additional filtering and normalization.

The resulting differential signal that is substantially independent of the effects of the local structure of the target is dependent on the difference in scattering characteristics at the different wavelength ranges.

Scattering characteristics of tissue are also dependent on the glucose concentration level of tissue fluids. This dependence occurs because scattering is caused by refractive index mismatches within the tissue. Tissue contains components that have small refractive index mismatches and therefore contain one or more weak scattering sites.

A specific example of an interface with a small refractive index mismatch is the interface between extra cellular fluid (ECF) with a refractive index of ˜1.348 to 1.352 and cellular membranes and protein aggregates with a refractive index of ˜1.350 to 1.460 in human tissue (the target).

The differential signal generated by processing signals acquired at the different wavelength ranges has the contribution of the tissue structure with large refractive index mismatch substantially removed and is therefore more sensitive to the effect of small refractive index mismatches due to changes in glucose concentration levels. The glucose scattering contribution at different wavelengths and at multiple depth locations is measured and, in particular, depth locations which have different dependencies on glucose, such as different layers within tissue (or the interfaces of such layers), such as skin tissue and in particular skin tissue with multiple layers within the depth range of OCT scanning.

The value of the glucose concentration level is calculated by means of a function using useful approximations such as those of Mie theory (well known to those skilled in the art). Alternatively the value of the glucose concentration level is established using correlation techniques such as those described in the U.S. Pat. No. 7,248,907 titled “Correlation of concurrent non-invasively acquired signals” incorporated herein by reference.

While the preferred embodiment of this invention for multiple wavelength OCT analysis uses two wavelength ranges and a multiple reference time domain OCT system (described in more detail in U.S. Pat. Nos. 7,526,329 and 7,751,862 incorporated herein), some other embodiments use more then two wavelength ranges. Also in other embodiments alternative OCT systems are used, including, but not limited to: conventional time domain OCT; swept source OCT; spectral domain OCT; mode-locked laser based OCT.

While the above described embodiment acquires scattering characteristics of the same region of the target at two different wavelength ranges simultaneously, other embodiments acquire scattering characteristics of substantially the same region of the target at two different wavelength ranges at different times but with small enough a time delay such that motion artifacts would be negligible. Such an approach, for example turning on different wavelength optical sources for sequential OCT scans, enables a simpler system with fewer components (for example, with a suitable choice of operational wavelengths, only one detector is required). Such an approach also facilitates a polarized system and balanced detection. For example for in vivo targets, scan rates of above one thousand scans per second provide sufficient scan speed that there is small enough time delay such that consecutive scans are taken at substantially the same time.

While the above described embodiment is described as a free space optical system (suitable for implementation on a micro optic bench), other embodiments include fiber based or waveguide based integrated optics.

While the above described embodiment is described with respect to measuring the glucose concentration level in tissue by exploiting the wavelength dependence on scattering properties, other embodiments measure the concentration level of other analytes based on other characteristics such as spectroscopic absorption instead of or in addition to scattering characteristics.

For example lactate concentration levels are measured by acquiring OCT signals with one or more wavelength ranges in an absorption wavelength range of lactic acid while also acquiring OCT signals with one or more wavelength ranges that have no or significantly reduced absorption by lactic acid and where both OCT signals are acquired at substantially the same locations within the target. Yet another example is measuring the oxygen level of blood.

While in the above described embodiment the target is tissue and in particular is skin tissue, other tissue regions could be target, for example tissue components of the eye, such as the cornea. Targets other than tissue are analyzable by the invention.

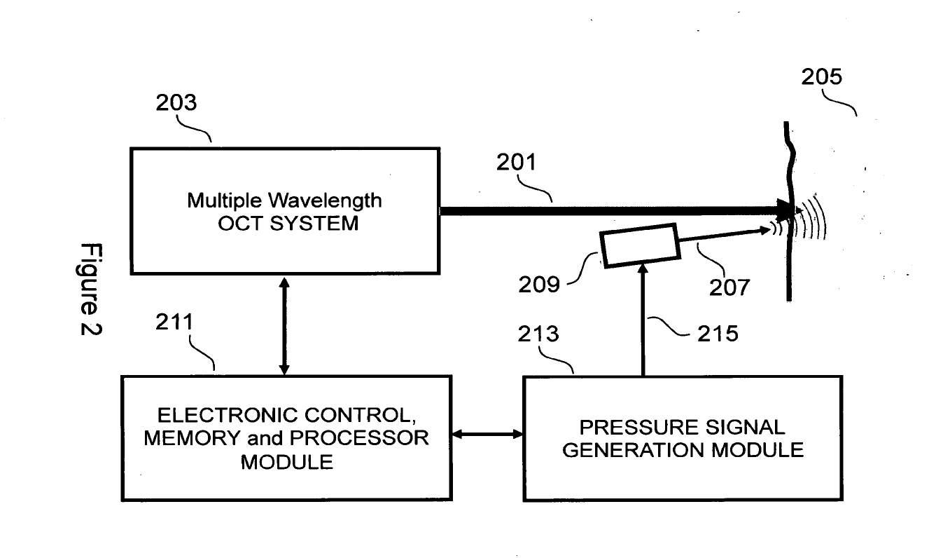

Alternatively, the above embodiments are used in conjunction with a pressure wave generator as depicted in FIG. 2 where the optical beam 201 of the multiple wavelength OCT system 203 is applied to the target 205 such as tissue. A pressure wave 207 generated by a pressure wave generator 209, is applied to the same region of the target 205 as the OCT system is probing.

An electronic control, memory and processor module 211 controls the operation of the OCT system. The module 211 also controls the operation of a pressure signal generation module 213. The module 211 also includes memory that stores digitized signals generated by the OCT system and a processor that processes the digitized OCT signals in conjunction with information about the pressure wave 207. The pressure drive signal 215 from the pressure signal generation module 213 controls the pressure generator 209.

The pressure wave may be applied to the target (tissue) to reduce speckle noise and/or to enhance the scattering signal related to small refractive index mismatches such as those related to glucose concentration level measurement. Techniques for application of a pressure wave to reduce speckle noise and/or to enhance the scattering signal related to small refractive index mismatches are described in the US patent application with docket number CI120925PC, titled “Enhanced OCT Measurement and Imaging Apparatus and Method” incorporated herein by reference.

Techniques for application of a pressure wave include, but are not limited to: continuously varying the frequency of the applied pressure wave to reduce speckle; alternating pressure wave environments for successive OCT scans; alternating pressure wave environments for successive sets of OCT scans.

Implementations include various combinations of the above embodiments. Wavelengths ranges are selected to suit particular applications, for example in the glucose concentration level measurement application wavelength ranges centered on at least two of 845 nm, 1050 nm or 1310 nm or other commonly used optical ranges are used.

Suitable wavelength ranges for applications involving tissue are centered on wavelengths that are substantially different from each other, such as, 845 nm, 1050 nm or 1310 nm and the magnitude of the ranges are such that they do not overlap. In other embodiments two or more ranges that are close to each other, or even overlapping ranges are used to generate a composite broadband optical source. This would simplify the optical coating requirements.

The contribution due to different wavelength ranges within the composite broad band range are separated out by processing or alternatively in the situation where the different wavelength ranges were generated by individual optical sources, such as SLDs, the individual optical sources are switched on for different time periods and include time periods where only one optical source was on (or combinations of sources being turned on).

In other embodiments the broadband optical source is a continuum generating source (such as a micro-ring based continuum source) which provides a very broadband optical range. In this embodiment the contribution due to different wavelength ranges within the composite broadband range are separated out by processing.

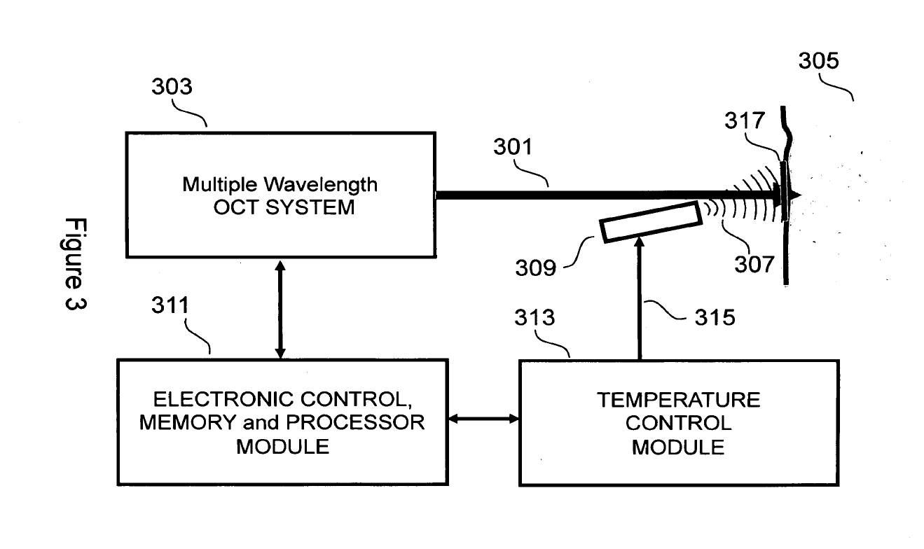

Yet another embodiment is depicted in FIG. 3 where the optical beam 301 of the multiple wavelength OCT system 303 is applied to the target (tissue in the preferred embodiment) 305. An alternating electro-magnetic wave 307 generated by an electro-magnetic wave generator 309, is applied to an element 317 that is in contact with the same region of the target 305 as the OCT system is probing.

At least some of the electro-magnetic wave 307 generates heat by induction in the element 317. Such conventional induction heating includes, but is not limited to, generating eddy currents (also referred to as Foucault currents) within the element 317. Alternatively induction heating is by means of generating magnetic hysteresis losses in materials that have high relative permeability.

An electronic control, memory and processor module 311 controls the operation of the OCT system. The module 311 also controls the operation of a temperature control module 313 that controls the electro-magnetic wave generator 309 via electrical connections 315. Optional conventional temperature sensors (either with or without direct contact) are used in some embodiments to monitor the actual temperature of the element 317 or the target 305.

The element 317 is transparent (anti-reflection coated and index matched) to enable the OCT optical bean 301 to pass through with minimal attenuation. Alternatively the element 317 has a hole or slot to enable the OCT optical beam 301 to pass through the element unimpeded. The element 317 is repeatedly attached to the same location of the target and then used by the OCT system to locate the region to be scanned.

Induction heating of the element 317 is used to temperature stabilize the location of the target 305 to be scanned by the multiple wavelength system OCT 303. Alternatively, or in addition to, induction heating of the element 317 is used to switch the temperature of the location of the target 305 to be scanned between two or more temperatures (as described in U.S. Pat. No. 8,078,244 by Melman, et al.).

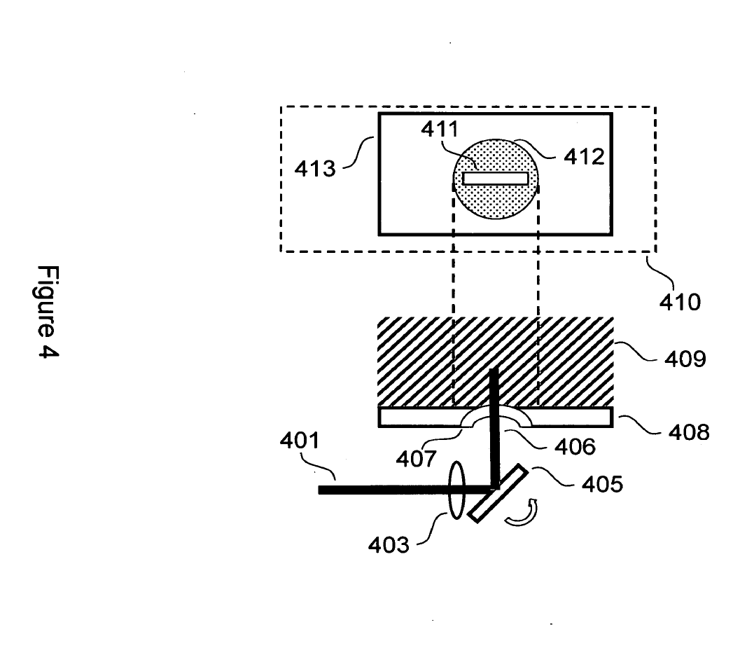

In addition to a depth scan of the target, a lateral scan of the target may be achieved by applying the probe beam of the OCT system to an angular scanning mirror (such means as a Galvo scanner or a MEMS angular scanner). This lateral scanning aspect is described in FIG. 4 where the probe beam 401 is focused into the target 409 by means of a focusing lens 403 and a turning mirror 405 mounted on an angular scanning device.

In one embodiment a curved transparent optical element 407 is located so that a path along the top surface is substantially a constant distant to the pivot point of the angularly scanning mirror, thereby ensuring the focused OCT probe beam 406 scans at a substantially constant depth within the target at any angular location.

In one embodiment the optical element 407 is thin in one lateral direction and is substantially surrounded by a capacitive micro-machined ultrasonic transducer (CMUT) which is used to generate an ultrasonic pressure wave which, in turn, is used to generate two different pressure wave environments within the target. The CMUT is also used as a combined ultrasonic generator array and ultrasonic detector array in order to acquire an ultrasound image of the target.

Using the CMUT array to generate two different pressure wave environments within the target generates a differential OCT signal in addition to or instead of a differential OCT signal generated by the two or more optical source wavelengths.

Using the CMUT array to generate an image of the target enables identifying the location of the OCT scan and the opportunity to correlate current OCT scans with previously acquired OCT scans. Identifying the target location is important for insuring that a measurement is made at the same location as a previous measurement was made. Having an image and knowing the relationship of an OCT scan with respect to the image enhances location correlation of a scan with a measurement site. The image is obtained either from a CMUT device or the OCT system itself.

The optical element 407 and the CMUT array are embedded in a heating element 408 which is used either to stabilize the temperature of the target or to switch the temperature of the target between two or more different values. In some embodiments conventional heating techniques is used.

While in some embodiments inductive heating may be used. other embodiments use a heat pump, for example based on the Peltier effect. Use of a heat pump enables better heat control and switching between different temperature states repeatedly at increased speed because of the ability to cool as well as heat.

A top view of one arrangement of the heater 408, CMUT and optical element 407 is depicted in the dashed rectangle 410 where the rectangular optical element 411, is surrounded by the CMUT array 412 and embedded in the heater 413.

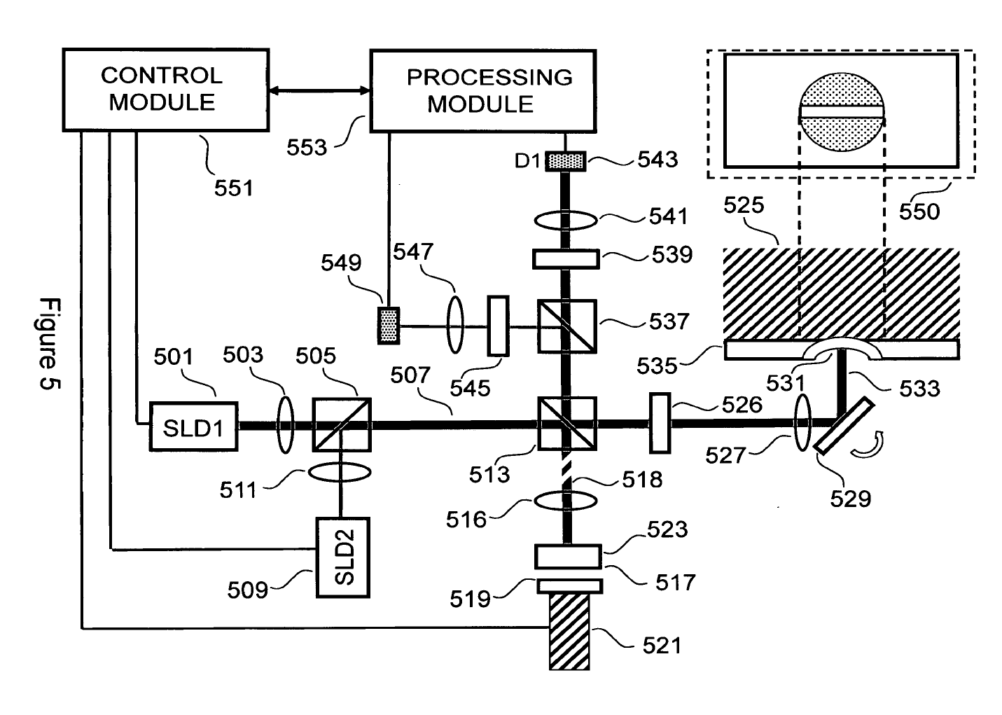

A preferred embodiment including a heat pump and a CMUT array is illustrated in FIG. 5 where a broadband optical source 501 generates broadband radiation with a wavelength range centered at a first wavelength. The first wavelength radiation is collimated by a lens 503 and passes substantially through a first beam-splitter 505 that is transmissive (or transparent) for radiation at the first wavelength range.

The first wavelength radiation is split into probe radiation and reference radiation by a second beam-splitter 513 which is a polarized beam splitter. The probe radiation is directed through a quarter wave plate 526 and through a focusing lens 527 at an angularly scanning mirror 529 that directs the focused probe radiation 533 at the target 525.

In this embodiment the probe radiation 533 passes through a curved transparent optical element 531 (described as optical element 407 of FIG. 4) that is in contact with the target 525, which in this embodiment is skin tissue. The curvature and thickness of the optical element are such that a path along the top surface is substantially a constant distant to the pivot point of the angularly scanning mirror, thereby ensuring the focused OCT probe beam 533 scans at a substantially constant depth within the target at any angular location.

The portion of the first wavelength radiation that is split off as reference radiation 518 by the second beam-splitter 513 is directed through a surface 523 that is anti-reflection coated and highly transmissive at the first wavelength range, through a second surface 517 that is partially reflective at the first wavelength range to a third surface 519 that is highly reflective at the first wavelength range.

The highly reflective surface 519 is mounted on an optical path length varying device 521, which, in the preferred embodiment, is a length varying piezo device, voice coil, or vertical scanning MEMs device. In the preferred embodiment the highly reflective surface 519 includes a thin wave plate that systematically rotates the plane of polarization of the reference radiation such that there is additional rotation of each reflection of the reference radiation (as depicted in FIG. 2 of U.S. Pat. No. 8,310,681 incorporated herein by reference).

The combination of the highly reflective surface 519 on the length varying piezo device 521 and the partial reflective surface 517 imposes different frequency content on different components of the reference radiation to form composite reference radiation reference radiation.

The thin wave plate of the highly reflective surface 519 causes portions of the different components of the reference radiation to be transmitted through the polarized beam splitter 513 to combine with the back scattered probe radiation, whose polarization vector has been rotated by the quarter wave plate 526.

The resulting combined back scattered probe radiation and composite reference radiation is transmitted through a third beam splitter 537, which is a highly transmissive at the first wavelength range. In the preferred embodiment the combined radiation passes through a polarization vector separator 539, such as a Glan Thompson polarizer that spatially separates the combined radiation into two orthogonal components.

The two orthogonal polarization vectors of the combined back scattered probe radiation and composite reference radiation are focused by a lens 541 and are detected by a two segment detector 543 (also labeled D1). In the preferred embodiment the composite interferometric signals resulting from combining captured scattered probe radiation with the composite reference radiation are thereby detected in a balanced detection mode for enhanced signal to noise ratio. The greater magnitude of higher order reference signal components also contributes to enhanced signal to noise ratio and thereby improved system sensitivity.

The resulting detected true and complementary composite interference signals are processed to achieve a scan of the target 525 that consists of a first set of scan segments that form a composite depth scan of a region of the target 525.

Referring again to FIG. 5 a second broadband optical source 509 generates broadband radiation with a wavelength range centered at a second wavelength (which second wavelength is different from the first wavelength). The second wavelength radiation is collimated by lens 511. The second wavelength radiation is combined with the first wavelength radiation by means of the beam-splitter 505 that is reflective for radiation at the second wavelength range. In the preferred embodiment, when combined, the first wavelength radiation and the second wavelength radiation are co-linear.

The second wavelength radiation is also split into probe and reference radiation by the second beam-splitter 513. The portion that is probe radiation is also directed at the target 525 and the portion that is reference radiation 518 is directed through a surface 523 that is also anti-reflection coated and highly transmissive at the second wavelength range, through the surface 517 that is also partially reflective at the second wavelength range to the third surface 519 that is also highly reflective at the second wavelength range.

The thin wave plate of the highly reflective surface 519 also causes portions of the different components of the reference radiation at this second wavelength range to be transmitted through the polarized beam splitter 513 to combine with the back scattered probe radiation at the second wavelength range, whose polarization vector has also been rotated by the quarter wave plate 526. Note: the optical path length from the beam splitter 513 to the highly reflective surface 519 is adjustable and is designed to be approximately equal to the optical path length from the beam splitter 513 to the surface region of the target 525 (as indicated by the segmented depiction of reference radiation 518 between the beam splitter 513 and lens 516).

The resulting combined back scattered probe radiation and composite reference radiation at the second wavelength is reflected by the third beam splitter 537, which is a highly reflective at the second wavelength range. In the preferred embodiment the combined radiation passes through a second polarization vector separator 545, such as a Glan Thompson polarizer that spatially separates the combined radiation into two orthogonal components.

As with the first wavelength radiation, the second wavelength combined back scattered probe radiation and composite reference radiation is focused with lens 547 onto the two segment detector 549 (also labeled D2). The detected true and complementary composite interference signals are processed to achieve a scan of the target 525 that consists of a second set of scan segments that form a composite depth scan of substantially the same region of the target 525 as is scanned by the first set of scan segments.

In the preferred embodiment, where the target 525 is tissue, the thin wave plate of the highly reflective surface 519 is selected such that the tenth, eleventh or twelfth order reference signal of the shorter of the two wavelength ranges has its polarization vector rotated by approximately 90 degrees (and thus substantially all of this component of the reference radiation is transmitted through the beam splitter 513 to the detection system).

The polarization vector of the longer wavelength reference radiation may not be rotated to the same extent as the shorter wavelength reference radiation and thus may have lower magnitude at the detector, however, in this embodiment the longer wavelength typically has greater penetration within the target 525. Applications involving other targets in some cases requires a different selection of the thin wave plate of the highly reflective surface 519 in order to optimize performance.

In this preferred embodiment the transparent optical element 531 is thin in one lateral direction and is substantially surrounded by a capacitive micro-machined ultrasonic transducer (CMUT), as described above with respect to FIG. 4. The CMUT is used to generate an ultrasonic pressure wave which, in turn, is used to generate two different pressure wave environments within the target. Alternatively, the CMUT is used as a combined ultrasonic generator array and ultrasonic detector array in order to acquire an ultrasound image of the target.

The optical element 531 and the CMUT array (depicted in the top view shown in the dashed rectangle 550 as described above with respect to 410 of FIG. 4) are embedded in a heating element 535 which in this preferred embodiment is a heat pump, based on the Peltier effect, which has the ability to cool as well as heat the target 525 and thereby can maintain a desired temperature more accurately and can cycle between different temperatures at a greater frequency than a heater with only heating capability.

In the preferred embodiment a control module 551 synchronously (a) drives the length modifying device 521 (b) drives the angular scanning mirror 529 (c) switches the CMUT device between at least two modes to generate at least two pressure wave environments (d) switches the region of interest of the target between at least two temperatures by controlling the heat pump.

In the preferred embodiment the two broadband optical sources 501 and 509 are both powered on for the duration of a measurement. In other embodiments, such as those using a single detection path, the control module 551 also controls the broadband optical sources 501 and 509.

In one mode of operation the heat pump maintains the region of interest of the target at a constant temperature while the CMUT generates a constant pressure wave environment and acquires an image of the target. The OCT depth scans acquired at the two wavelength ranges are processed by the processing module 553 to generate differential signal that is less sensitive to gross structural properties of the tissue target and more sensitive to the difference in the scattering properties of the tissue target at different wavelengths.

In another mode the heat pump maintains the region of interest of the target at a constant temperature while the CMUT generates different pressure wave environments to enhance the OCT analysis capability at each of the different wavelength ranges. In one mode, optimally switching between the two pressure wave environments is done synchronously with the motion of the length modifying device 521. For example alternate bi-directional scans may have different pressure wave environments.

Alternatively, switching between the two pressure wave environments is done synchronously with the motion of the angular scanning mirror 529. For example the target may be subjected to different pressure wave environments for the duration of alternate bi-directional scans of the angularly scanning mirror.

In another mode the heat pump is operated to switch the temperature of the region of interest of the target between at least two temperatures. This is done as a one time switch between two temperatures or as a repeated cycle between at least two temperatures. In this mode the CMUT is also used to switch between generating two pressure environments in the manner described in the above mode or synchronously with the temperature switching. In another variation of this mode the CMUT is used only for imaging or disabled.

In this embodiment the system depicted in FIG. 5 performs depth scans of a tissue target in multiple differential modes thereby reducing sensitivity to structural properties of the target and increasing sensitivity to other properties of the target. Various combinations of the differential are possible including, but not limited to the following combinations.

One combination provides differential wavelength mode where the same region of the target OCT depth scanned by radiation centered on at least two wavelength ranges while the target is maintained at a constant temperature.

Another combination provides differential wavelength and pressure mode where the same region of the target OCT depth scanned by radiation centered on at least two wavelength ranges and the target is also subjected to two different pressure wave environments while the target is maintained at a constant temperature.

Another combination provides differential wavelength and temperature mode where the same region of the target OCT depth scanned by radiation centered on at least two wavelength ranges and the target is also sequentially and optionally repeatedly subjected to two different temperatures.

A further combination provides differential wavelength, pressure and temperature mode where the same region of the target OCT depth scanned by radiation centered on at least two wavelength ranges and the target is also subjected to two different pressure wave environments and also sequentially and optionally repeatedly subjected to two different temperatures.

Different differential modes and subsequent processing are suitable for different applications. For example in a glucose concentration measurement application the magnitude of the back scattered radiation at different wavelength ranges can be processed to determine scattering coefficients at different depths within the target.

Scattering coefficients at different depths within the target are processed to determine scattering depth profiles. Back scattered radiation at different wavelength ranges is also processed to determine spectroscopic information at different depths within the target. Scattering coefficients or spectroscopic information at different depths are related to scattering depth profiles and adjacent lateral scans, for example obtained by an angularly scanning mirror, are averaged.

Correlating structural aspects of the target, such as tissue layer boundaries, by means of scattering depth profiles enhances refinement of depth location of scattering coefficients or spectroscopic information within the region of interest of the target. In the particular case of acquiring spectroscopic information, multiple optical sources with different center wavelengths replace either or both of the single optical sources 501 and 509.

In this embodiment, only one of the replacement optical sources for 501 and only one replacement source for 509 would be turned at a given time (for example the duration of an A-scan). An advantage of using OCT to acquire spectroscopic information is that the source of the spectral information has a more defined volume than in conventional spectroscopy. A further advantage of acquiring at least two wavelength ranges OCT measurements simultaneously is that it ensures the two spectroscopic measurements are derived from substantially the same volume of the target.

In spectroscopic applications the wavelength ranges of the optical sources may be selected to match the spectral characteristics of a particular analyte whose concentration is to be measured.

A two or three dimensional image of the region of interest of the target provides enhanced location correlation of OCT scans. Such an image is acquired by operating a CMUT array for at least a portion of the duration of the OCT measuring process in an imaging mode. Alternately such an image is acquired by operating a conventional camera (such as a CCD camera or other imaging device) for at least a portion of the duration of the OCT measuring process.

While the preferred embodiment is described as a free space optical system (suitable for implementation on a micro optic bench), other embodiments may be fiber based or waveguide based integrated optics. While the preferred embodiment is a time domain multiple reference OCT system, other OCT systems such as a conventional time domain OCT system, or a spectral domain OCT system, or a Fourier domain swept source OCT system may be used as the multiple wavelength range OCT system.

While the preferred embodiment described in FIG. 5 the highly reflective surface 519 includes a thin wave plate, in other embodiments the thin wave plate of the reference arm is replaced with a more conventional quarter wave plate (similar to 526 in the sample arm) between the beam splitter 513 and the lens 516.

While the preferred embodiment described provide superluminescent diodes as the optical sources, other optical sources include, but are not limited to, LEDs or continuum generation sources.

While in the above described embodiment the target is tissue and in particular is skin tissue, alternate embodiments include other tissue regions as the target, for example tissue components of the eye, such as the cornea or biometric applications, such as finger prints. The invention analyzes targets other than tissue. Non biological targets include, but are not limited to: documents including bank notes and currency; items of manufacture, such as, contact lenses, bio-medical devices, opto-electronic components.

While in the preferred embodiment the target is scanned in one lateral dimension by means of an angularly scanning mirror mounted on a device such as a galvo or MEMS scanner, in other embodiments conventional one or two dimensional galvo or MEMS scanners are used, or the multiple wavelength OCT system is translated in one or two lateral dimensions.

While the invention has been described by means of specific embodiments and applications thereof, it is understood that numerous modifications and variations made thereto by those skilled in the art do not depart from the spirit and scope of the invention. It is therefore to be understood that within the scope of the claims, the invention may be practiced otherwise than as specifically described herein.

1. (canceled)

2. (canceled)

3. (canceled)

4. (canceled)

5. (canceled)

6. (canceled)

7. (canceled)

8. A method of measuring optical properties of a region of interest of a target at at least two wavelength ranges comprising:
using an optical coherence tomography system to measure, at at least two wavelength ranges, intensities of back scattered radiation from a target of interest;
where, for the duration of at least one optical coherence tomography scan, said region of interest of said target is subjected to a pressure wave to reduce speckle;
and
processing said scattering intensities so that target measurements are made at substantially the same location.

9. The method of claim 8 where, for a first portion of the duration of a set of optical coherence tomography scans said region of interest of said target is subjected to a first pressure wave environment and for a second portion of the duration of said set of optical coherence tomography scans said region of interest of said target is subjected to a second pressure wave environment to further enhance processing of said scattering intensities.

10.-21. (canceled)

22. A system for measuring optical properties of a region of interest of a target at at least two wavelength ranges comprising:
an optical coherence tomography system to measure, at at least two wavelength ranges and at substantially the same location in the region of interest of a target, intensities of back scattered radiation from said target of interest;
a pressure wave generator, which subjects said region of interest to a pressure wave for the duration of at least one optical coherence tomography scan, so as to reduce speckle; and
a processing module to process scattering intensities at the said at least two wavelength ranges.

23. The system of claim 22, further including a pressure wave generator which, for a first portion of the duration of a set of optical coherence tomography scans, subjects said region of interest of said target to a first pressure wave environment, and for a second portion of the duration of a set of optical coherence tomography scans, subjects said region of interest of said target to a second pressure wave environment, so as to enhance processing of the scattering intensities.

24-27. (canceled)
